(19) United States
(12) Patent Application Publication
(10) Pub. No.: US 2002/0166841 A1
(43) Pub. Date: Nov. 14, 2002

(54) Electrode of vacuum circuit breaker, and method of producing electrode of vacuum circuit breaker

(75) Inventors: Hidemitsu Takebuchi, Chiba (JP); Yoshihiko Matsui, Shizuoka (JP); Akira Nishijima, Shizuoka (JP); Yoshihiro Fukatsu, Shizuoka (JP)

Correspondence Address: FOLEY AND LARDNER, SUITE 500, 3000 K STREET NW, WASHINGTON, DC, 20007, US

(73) Assignee: KABUSHIKI KAISHA MEIDENSHA

(21) Appl. No.: 10/083,500

(22) Filed: Feb. 27, 2002

(30) Foreign Application Priority Data
May 9, 2001 (JP) 2001-138213

(51) Int. Cl. H01H 33/66

(52) U.S. Cl. 218/123

(57) ABSTRACT

An electrode of a vacuum circuit breaker has a cup member and a contact. The cup member has an opening and a periphery which is formed with a slit so as to form a coil section. An electric current flows in the coil section so as to generate a longitudinal magnetic field in a direction along an axis of the cup member. The slit is bent and continuously extends on the periphery from a first end of the cup member to a second end of the cup member opposite to the first end of the cup member. The contact is shaped into a plate, and seals the opening of the cup member.

### BACKGROUND OF THE INVENTION

1. Field of the Invention

The present invention relates to an electrode of a vacuum circuit breaker, and a method of producing the electrode of the vacuum circuit breaker. Especially, the present invention is applicable to an electrode which is shaped substantially into a cup and has a longitudinal magnetic field.

2. Description of the Related Art

An electric arc occurs between electrodes during circuit break. For improving breaking capability of a vacuum circuit breaker, an entire surface of each of the electrodes is subjected to a damage caused by the electric arc. In other words, concentration of the electric arc in one spot on the surface should be prevented. For receiving the damage (caused by the electric arc) on the entire surface, a constitution having a longitudinal magnetic-field electrode (axial magnetic-field electrode) is adopted, as is seen in FIG. 7 and FIG. 8.

As is seen in FIG. 7, there is provided a constitution of the longitudinal magnetic-field electrode having an electrode 01 (immovable side) and an electrode 02(movable side). The electrode 01 is constituted of a contact 01a, and a coil electrode 01b which is disposed on a side opposite to a contact face of the contact 01a. The movable electrode 02 is constituted of a contact 02a, and a coil electrode 02b which is disposed on a side opposite to a contact face of the contact 02a. Each of the coil electrode 01b and the coil electrode 02b has an arm extending radially from an axial center thereof. The arm has a peak end which is fitted with a coil extending circumferentially. With electric current flowing in the coil circumferentially, a magnetic field is caused in parallel with the electric arc (longitudinal magnetic field). The longitudinal magnetic field applied to the electric arc prevents radial diffusion of charged particles, to thereby stabilize the electric arc. The thus stabilized electric arc reduces loss, to thereby control increase in temperature of the electrode. With this, the breaking capability of the vacuum circuit breaker is improved.

The longitudinal magnetic-field electrode is, however, complicated in overall constitution. Moreover, each component part used for the longitudinal magnetic-field electrode is also complicated in constitution (unit constitution). Therefore, producing the longitudinal magnetic-field electrode is costly. For reducing the production cost, the longitudinal magnetic-field electrode should be simple in constitution and reduced in number of component parts.

As is seen in FIG. 8, there is provided a constitution of the longitudinal magnetic-field electrode having an electrode 011 and an electrode 012 opposed to the electrode 011. On a periphery of a cup member of the electrode 011, a slit 011a (inclined) is formed to provide a coil section 011b. On a periphery of a cup member of the electrode 012, a slit 012a (inclined) is formed to provide a coil section 012b. Moreover, the cup member of the electrode 011 has an opening which is sealed with a contact 011c, while the cup member of the electrode 012 has an opening which is sealed with a contact 012c.

As is seen in FIG. 9 (cross section of the longitudinal magnetic-field electrode in FIG. 8), the electrode 011 has a reinforcing pipe 011d in addition to the cup member (coil section 011b) and the contact 011c, while the electrode 012 has a reinforcing pipe 012d in addition to the cup member (coil section 012b) and the contact 012c. Each of the reinforcing pipe 011d and the reinforcing pipe 012d is mated in a hollow section of the cup member, so as to reinforce stability (of the longitudinal magnetic-field electrode) against mechanical impact caused by a contacting of the contact 0111c on the contact 012c when the vacuum circuit breaker is inputted.

The longitudinal magnetic-field electrode (having the cup member) in FIG. 8 and FIG. 9 is smaller in number of component parts than the longitudinal magnetic-field electrode in FIG. 7. However, it is necessary for the cup member in FIG. 8 and FIG. 9 to be formed with the slit 011a and the slit 012a, so as to provide, respectively, the coil section 011b and the coil section 012b.

Therefore, as is seen in FIG. 10, there is provided a turn blade 013 shaped substantially into a disk. For machining the cup member (copper) so as to form the slit 011a and the slit 012a, the turn blade 013 is turned with a predetermined inclination angle relative to the cup member. Conventionally, this is a general machining (slitting) method.

As shown in FIG. 10, machining with the turn blade 013 has advantages such as easiness and low cost. The machining with the turn blade 013 has, however, difficulty in securing a long circumferential dimension of the slit 011a and the slit 012a. Smaller inclination angle of the turn blade 013 (relative to the cup member) makes the machining more difficult.

The longitudinal magnetic field between the electrode 011 and the electrode 012 is proportional to a product of electric current (flowing in each of the coil section 011b and the coil section 012b) and a turning angle. The product is defined as “ampere·turn=i·n”. In other words, the circumferential length of each of the slit 011a and the slit 012a is an important determinant of the turning angle (number of turns n) of the electric current. The longer the circumferential length is, the higher the longitudinal magnetic field is.

The above summarizes that the electrode 011 (having the cup member) and the electrode 012 (having the cup member) constituting the longitudinal magnetic field according to the related art have a difficulty in obtaining strong magnetic field, and therefore are not sufficient for the vacuum circuit breaker that requires capability of breaking a high voltage and a large electric current.

Moreover, the vacuum circuit breaker with the electrode 011 and the electrode 012 according to the above related art is disadvantageous in terms of strength for the following causes: The smaller the inclination angle of slitting the slit 011a and the slit 012a is, the more acute the junction A (see FIG. 8) is. The acuteness of the junction A (coil section 011b with the contact 011c, and the coil section 012b with the contact 012c) causes stress concentration. Thereby, the junction A is likely to peel after repeated operations (opening and closing) of the electrode 011 and the electrode 012 of the vacuum circuit breaker.

Hereinafter described are more details of the vacuum circuit breaker having the electrode 011 and the electrode 012.

As is seen in FIG. 11, there is provided a conceptual view of the vacuum circuit breaker having the electrode 011 and the electrode 012. The vacuum circuit breaker is constituted of a vacuum envelope 017, the electrode 011 and the electrode 012 as main component parts. The vacuum envelope 017 has an insulator tube 014 made of material such as ceramic, glass and the like. The insulator tube 014 has a first end (upper) sealed with an end plate 015 made of metal, and a second end (lower) sealed with an end plate 016 made of metal. With the thus sealed internal section, the vacuum envelope 017 is highly exhausted (vacuum). In the vacuum envelope 017, the electrode 011 is fixed to an end (lower in FIG. 11) of an immovable rod 018 while the electrode 012 is fixed to an end (upper in FIG. 11) of a movable rod 019. The electrode 011 and the electrode 012 are opposed to each other, and make a relative movement toward (contacting) and away (parting) from each other. With an inclination, an electric current I flows in the coil section 011b (of the electrode 011) and the coil section 012b (of the electrode 012), to thereby generate a longitudinal magnetic field B. With the thus generated longitudinal magnetic field B, the vacuum circuit breaker has a good breaking capability. In FIG. 11, also shown are a bellows 020 and an intermediate shield 021.

### BRIEF SUMMARY OF THE INVENTION

It is, therefore, an object of the present invention to provide an electrode of a vacuum circuit breaker. The electrode under the present invention is the one that is shaped into a cup and has a longitudinal magnetic field, and that causes such a strong magnetic field as to feature a preferable breaking capability. Moreover, the electrode under the present invention is the one that features a sufficient mechanical strength even after repeated opening and closing operations (of a movable electrode and an immovable electrode).

It is another object of the present invention to provide a method of producing, with ease, the electrode of the vacuum circuit breaker featuring the preferable breaking capability and the sufficient mechanical strength, as described above.

According to a first aspect of the present invention, there is provided an electrode of a vacuum circuit breaker. The electrode comprises a cup member and a contact. The cup member has an opening and a periphery which is formed with a slit so as to form a coil section. An electric current flows in the coil section so as to generate a longitudinal magnetic field in a direction along an axis of the cup member. The slit is bent and continuously extends on the periphery from a first end of the cup member to a second end of the cup member opposite to the first end of the cup member. The contact is shaped into a plate, and seals the opening of the cup member.

According to a second aspect of the present invention, there is provided a method of producing an electrode of a vacuum circuit breaker. The electrode comprises a cup member having an opening which is sealed with a contact shaped into a plate. The cup member has a periphery which is formed with a slit so as to form a coil section. An electric current flows in the coil section so as to generate a longitudinal magnetic field in a direction along an axis of the cup member. The method comprises the following operations of: turning the cup member around the axis of the cup member by a predetermined rotational feed angle relative to a tool; and feeding the tool, in the direction along the axis of the cup member, relative to the cup member during the turning operation of the cup member, so as to form the slit which is bent and continuously extending on the periphery from a first end of the cup member to a second end of the cup member opposite to the first end of the cup member.

According to a third aspect of the present invention, there is provided a vacuum circuit breaker comprising a pair of a first electrode and a second electrode opposite to the first electrode. Each of the first electrode and the second electrode comprises a cup member and a contact. The cup member has an opening and a periphery which is formed with a slit so as to form a coil section. An electric current flows in the coil section so as to generate a longitudinal magnetic field in a direction along an axis of the cup member. The slit is bent and continuously extends on the periphery from a first end of the cup member to a second end of the cup member opposite to the first end of the cup member. The contact is shaped into a disk plate, and seals the opening of the cup member.

The other objects and features of the present invention will become understood from the following description with reference to the accompanying drawings.

### BRIEF DESCRIPTION OF THE SEVERAL VIEWS OF THE DRAWINGS

FIG. 1 is a perspective view of an electrode 1 (electrode 2), according to a first embodiment of the present invention;

FIG. 2 is a cross sectional view of the electrode 1 (electrode 2) shown in FIG. 1;

FIG. 3 is a perspective view of a method of producing the electrode 1 (electrode 2) in FIG. 1;

FIG. 4 is a radial distribution of a longitudinal magnetic element in a cross section at substantially the middle of the electrode 1 (electrode 2) according to the first embodiment, as compared with that of an electrode according to a related art;

FIG. 5 is a front view of an electrode 11 (electrode 12), according to a second embodiment of the present invention;

FIG. 6 is a front view of an electrode 21 (electrode 22), according to a third embodiment of the present invention;

FIG. 7 is a perspective view of an electrode 01 (electrode 02), according to a first example of the related art;

FIG. 8 is a perspective view of an electrode 011 (electrode 012), according to a second example of the related art;

FIG. 9 is a longitudinal cross section of the electrode 011 (electrode 012) shown in FIG. 8;

FIG. 10 is a perspective view of a method of producing the electrode 011 (electrode 012) shown in FIG. 8; and

FIG. 11 is a schematic of a vacuum circuit breaker having the electrode 011 (electrode 012) shown in FIG. 8.

### DETAILED DESCRIPTION OF THE EMBODIMENT

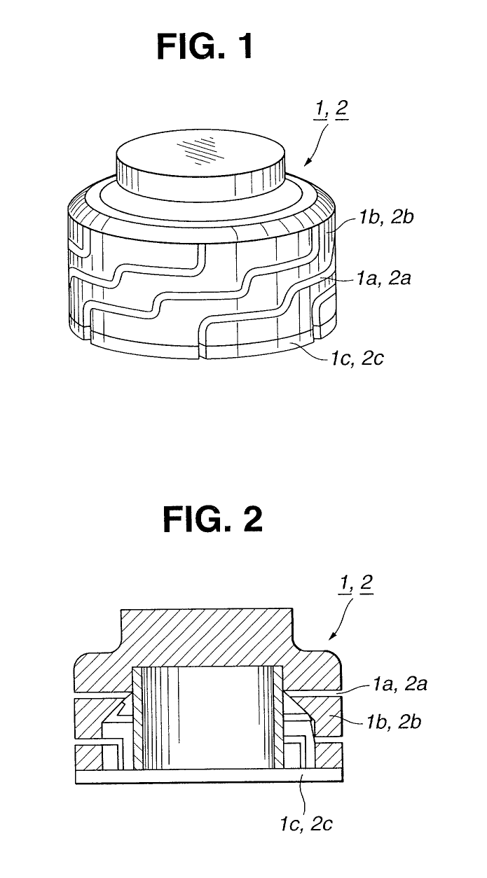

As is seen in FIG. 1, there are provided an electrode 1 and an electrode 2, according to a first embodiment of the present invention.

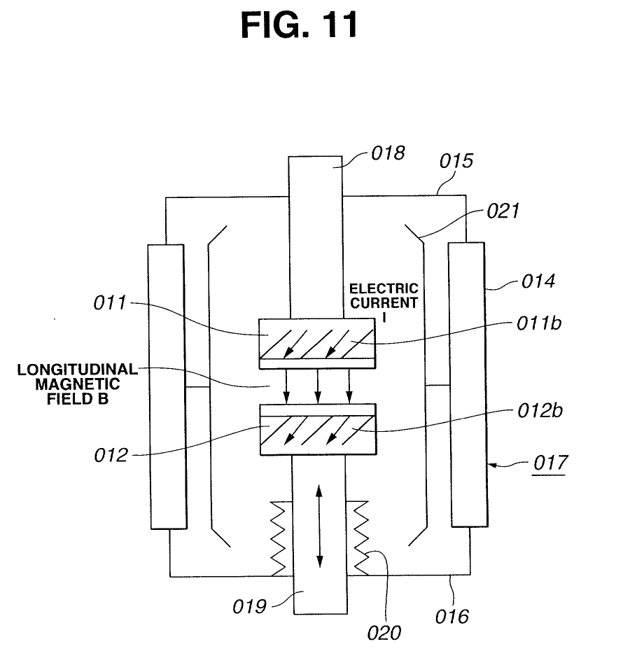

Like the electrode 011 and the electrode 012 in FIG. 11, the electrode 1 is fixed to the end (lower in FIG. 11) of the immovable rod 018 while the electrode 2 is fixed to the end (upper in FIG. 11) of the movable rod 019. The electrode 1 and the electrode 2 are opposed to each other, and make a relative movement toward (contacting) and away (parting) from each other. Moreover, the electrode 1 is constituted of a cup member and a contact 1c (shaped substantially into a disk) for sealing an opening of the cup member, while the electrode 2 is constituted of a cup member and a contact 2c (shaped substantially into a disk) for sealing an opening the cup member. The relative movement of the contact 1c and the contact 2c toward (contacting) and away (parting) from each other opens and closes the electric path.

According to the first embodiment, the cup member of the electrode 1 has a periphery which is formed with a slit 1a extending continuously and stepwise from a first end of the cup member to a second end of the cup member, while the cup member of the electrode 2 has a periphery which is formed with a slit 2a extending continuously and stepwise from a first end of the cup member to a second end of the cup member. Each of the slit 1a and the slit 2a is plural in number, to thereby form, respectively, a coil section 1b and a coil section 2b.

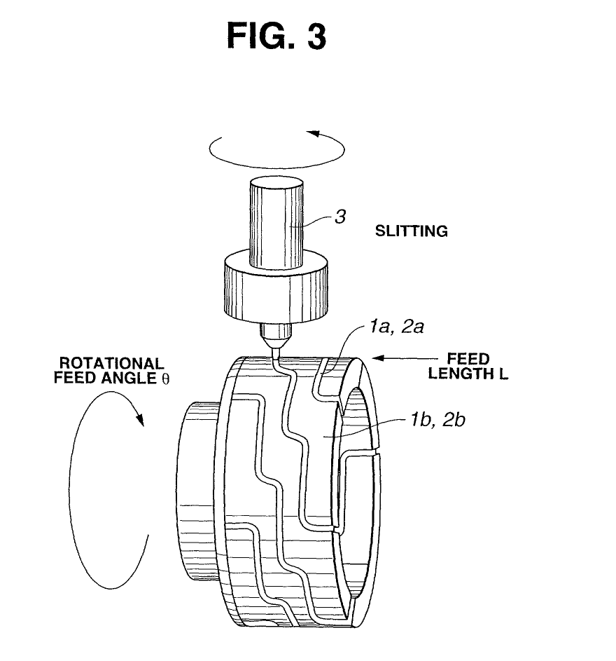

Hereinafter described referring to FIG. 3 is how to form the slit 1a and the slit 2a. The cup member is turned axially by a predetermined rotational feed angle θ. With a drill 3 (tool) being turned during the turning of the cup member, the cup member is fed axially by a feed length L. Herein, varying arbitrarily the rotational feed angle θ and the feed length L forms an arbitrarily bent slit. For forming the slit 1a and the slit 2a that are shaped stepwise, the above “turning” and “axial feeding” are carried out alternatively and intermittently. The drill 3 used as the tool can be replaced with a wire cut, a tip saw, a water jet and the like. The number of the plurality of the slits 1a and the slit 2a is not specifically limited.

Each of the slit 1a (of the electrode 1) and the slit 2a (of the electrode 2) according to the first embodiment is formed stepwise. Therefore, electric circuit has substantially a constant cross section. Moreover, in the vicinity of each of a first junction (between the coil section 1b and the contact 1c) and a second junction (between the coil section 2b and the contact 2c), a sufficient electric current flows toward an end face of the respective slit 1a and slit 2a.

Furthermore, an inclination (of each of the slit 1a and the slit 2a) relative to an axial line (of the cup member of each of the respective electrode 1 and electrode 2) is >enlarged (Hereinafter, the inclination is referred to as “circumferential slit angle.”). As a result, each of the slit 1a and the slit 2a is elongated circumferentially, to thereby secure sufficient longitudinal magnetic strength corresponding to breaking capability of breaking a required high voltage and large electric current.

Moreover, each of the slit 1a and the slit 2a is formed substantially perpendicular, respectively, to the contact 1c and the contact 2c, at the first and the second end thereof. The above perpendicularity contributes to reduction in stress concentration which is caused by a mechanical impact when the vacuum circuit breaker is input. Therefore, even repeated operations (opening and closing) of the vacuum circuit breaker are unlikely to cause failures such as peeling at the first junction (between the coil section 1b and the contact 1c) and the second junction (between the coil section 2b and the contact 2c).

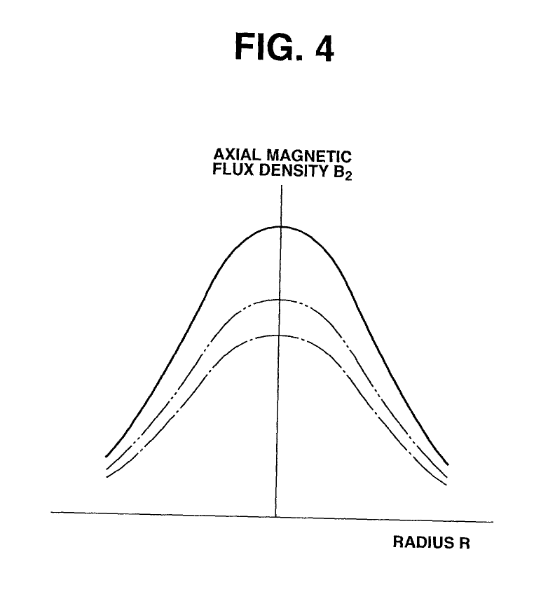

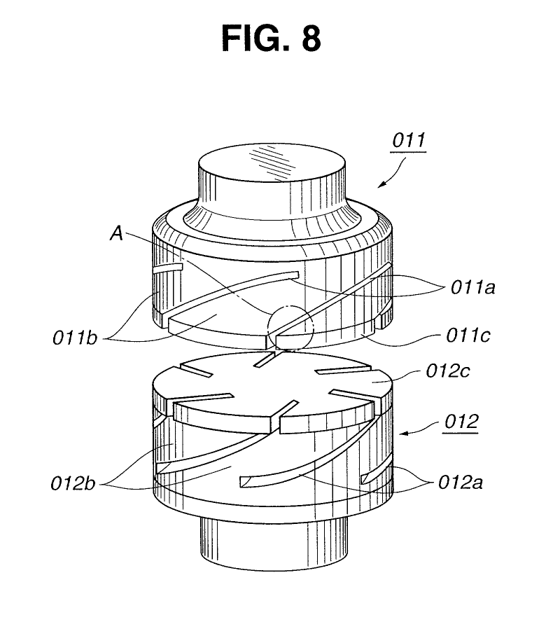

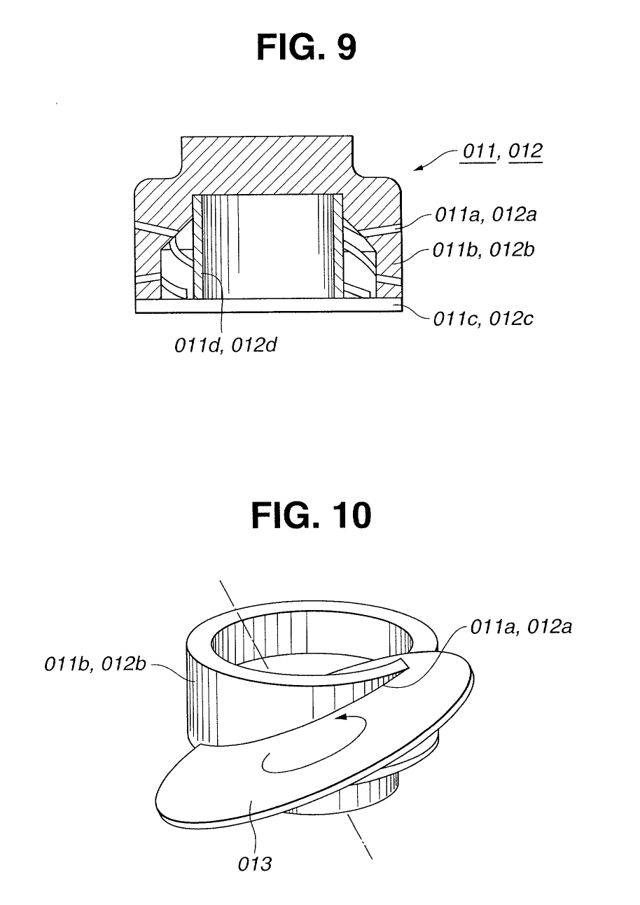

FIG. 4 shows a radial distribution of a longitudinal magnetic element in a cross section at substantially the middle of the electrode 1 (the electrode 2) according to the first embodiment of the present invention, as compared with that of the electrode 011 (the electrode 012) according to the related art in FIG. 8 to FIG. 10. The vertical axis in FIG. 4 is a magnetic flux density B₂ (T/A) per unit current, while the horizontal axis is a radius R of the electrode 1 (the electrode 2) and the electrode 011 (the electrode 012).

In FIG. 4, a one-dot chain curve (lower) shows a characteristic of the electrode 011 (the electrode 012) with the circumferential slit angle 120°, according to the related art.

In FIG. 4, a two-dot chain curve (middle) shows a characteristic of the electrode 1 (the electrode 2) with the circumferential slit angle 120°, according to the first embodiment of the present invention. Herein, the electrode 1 (the electrode 2) is the one that is formed with the stepwise slit 1a (the stepwise slit 2a).

In FIG. 4, a solid curve (upper) shows a characteristic of the electrode 1 (the electrode 2) with the circumferential slit angle 180°, according to the first embodiment of the present invention. Herein. the electrode 1 (the electrode 2) is the one that is formed with the stepwise slit 1a (the stepwise slit 2a) in FIG. 1.

As is seen in FIG. 4, even with the circumferential slit angle 120° (middle in FIG. 4), the electrode 1 (the electrode 2) according to the first embodiment shows the longitudinal magnetic field (magnetic flux density) stronger, by about 20%, than that of the electrode 011 (the electrode 012) according to the related art (lower in FIG. 4). With the circumferential slit angle 180° (upper in FIG. 4), the electrode 1 (the electrode 2) according to the first embodiment shows much stronger longitudinal magnetic field (magnetic flux density) than that of the electrode 011 (the electrode 012) according to the related art (lower in FIG. 4).

Although the present invention has been described above by reference to the first embodiment, the present invention is not limited to the first embodiment described above. Modifications and variations of the first embodiment described above will occur to those skilled in the art, in light of the above teachings.

More specifically, as is seen in FIG. 1, each of the slit 1a (of the electrode 1) and the slit 2a (of the electrode 2) is formed stepwise. The configuration of each of the slit 1a and the slit 2a is, however, not limited to stepwise. Any other configuration is allowed provided that the minimum requirements described in the following two sentences are met: 1. The inclination angles (relative to the axial line of the cup member of each of the electrode 1 and the electrode 2) are formed by a continuous curve that is a combination of a plurality of different types of straight line segments. 2. The inclination is substantially perpendicular to a reverse face of each of the contact 1c and the contact 2c. The above two minimum requirements are for enlarging the circumferential slit angle so as to elongate the coil section 1b and the coil section 2b, and for reducing the stress concentration at the first junction (between the coil section 1b and the contact 1c) and the second junction (between the coil section 2b and the contact 2c).

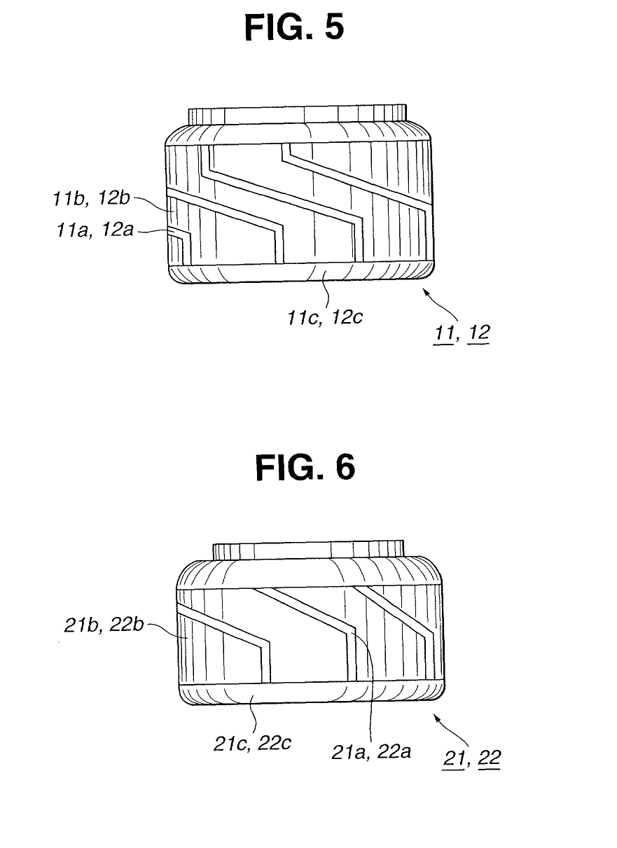

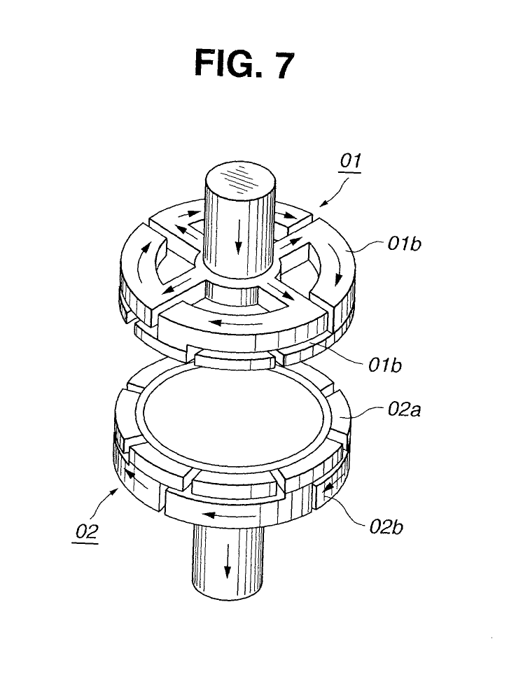

Other allowable configurations are seen in FIG. 5 and FIG. 6.

As is seen in FIG. 5, there are provided an electrode 11 having a slit 11a, a coil section lib and a contact 11c; and an electrode 12 having a slit 12a, a coil section 12b, and a contact 12c, according to a second embodiment of the present invention.

As is seen in FIG. 6, there are provided an electrode 21 having a slit 21a, a coil section 21b, and a contact 21c; and an electrode 22 having a slit 22a, a coil section 22b, and a contact 22c, according to a third embodiment of the present invention.

With the rotational feed angle ζ and the feed length L controlled arbitrarily through the method shown in FIG. 3, each of the slit 11a (of the electrode 11), the slit 12a (of the electrode 12), the slit 21a (of the electrode 21) and the slit 22a (of the electrode 22) is formed.

The entire contents of basic Japanese Patent Application No. P2001-138213 (filed on May 9, 2001) of which priority is claimed is incorporated herein by reference.

The scope of the present invention is defined with reference to the following claims.

What is claimed is:

1. An electrode of a vacuum circuit breaker, comprising:
a cup member having an opening and a periphery which is formed with a slit so as to form a coil section, an electric current flowing in the coil section so as to generate a longitudinal magnetic field in a direction along an axis of the cup member, the slit being bent and continuously extending on the periphery from a first end of the cup member to a second end of the cup member opposite to the first end of the cup member; and
a contact shaped into a plate, and sealing the opening of the cup member.

2. The electrode of the vacuum circuit breaker as claimed in claim 1, in which the bent slit is formed stepwise.

3. The electrode of the vacuum circuit breaker as claimed in claim 1, in which the bent slit is a combination of:
a first line segment having a first end which is substantially perpendicular to a reverse face of the contact, the reverse face sealing the opening of the cup member, and
a second line segment continuously connected to a second end of the first line segment opposite to the first end of the first line segment; and
the first segment and the second segment form an inclination.

4. The electrode of the vacuum circuit breaker as claimed in claim 1, in which the bent slit is plural in number.

5. The electrode of the vacuum circuit breaker as claimed in claim 1, in which the contact is shaped substantially into a disk plate.

6. A method of producing an electrode of a vacuum circuit breaker, the electrode comprising a cup member having an opening which is sealed with a contact shaped into a plate, the cup member having a periphery which is formed with a slit so as to form a coil section, an electric current flowing in the coil section so as to generate a longitudinal magnetic field in a direction along an axis of the cup member, the method comprising the following operations of:
turning the cup member around the axis of the cup member by a predetermined rotational feed angle relative to a tool; and
feeding the tool, in the direction along the axis of the cup member, relative to the cup member during the turning operation of the cup member, so as to form the slit which is bent and continuously extending on the periphery from a first end of the cup member to a second end of the cup member opposite to the first end of the cup member.

7. The method of producing the electrode of the vacuum circuit breaker as claimed in claim 6, in which the turning operation and the feeding operation are carried out alternatively.

8. The method of producing the electrode of the vacuum circuit breaker as claimed in claim 6, in which the turning operation and the feeding operation are carried out intermittently.

9. The method of producing the electrode of the vacuum circuit breaker as claimed in claim 6, in which the tool is a drill.

10. A vacuum circuit breaker comprising:
a pair of a first electrode and a second electrode opposite to the first electrode, each of the first electrode and the second electrode comprising:
a cup member having an opening and a periphery which is formed with a slit so as to form a coil section, an electric current flowing in the coil section so as to generate a longitudinal magnetic field in a direction along an axis of the cup member, the slit being bent and continuously extending on the periphery from a first end of the cup member to a second end of the cup member opposite to the first end of the cup member; and
a contact shaped into a disk plate, and sealing the opening of the cup member.

11. The vacuum circuit breaker as claimed in claim 10, in which the bent slit of each of the first electrode and the second electrode is formed stepwise.

12. The vacuum circuit breaker as claimed in claim 10, in which the bent slit is a combination of:
a first line segment having a first end which is substantially perpendicular to a reverse face of the contact, the reverse face sealing the opening of the cup member, and
a second line segment continuously connected to a second end of the first line segment opposite to the first end of the first line segment; and
the first segment and the second segment form an inclination.

13. The vacuum circuit breaker as claimed in claim 10, in which the bent slit is plural in number.
